(19) United States
(12) Patent Application Publication
(10) Pub. No.: US 2011/0081640 A1
(43) Pub. Date: Apr. 7, 2011

(54) Systems and Methods for Protecting Websites from Automated Processes Using Visually-Based Children's Cognitive Tests

(76) Inventors: Hsia-Yen Tseng, San Diego, CA (US); Haw-minn Lu, San Diego, CA (US)

(21) Appl. No.: 12/899,552

(22) Filed: Oct. 7, 2010

Related U.S. Application Data
(60) Provisional application No. 61/249,567, filed on Oct. 7, 2009.

(51) Int. Cl. G09B 7/00

(52) U.S. Cl. 434/362

(57) ABSTRACT

Visually based children's cognitive tests can be used as a human challenge or Turing test to verify that a human and not an automated process is operating a particular system, such as purchasing tickets, downloading files, accessing a database, or requesting a reprieve from an anti-spam system. Several different visually oriented cognitive tests can be used as a human challenge, for example, selecting one object in a group of object that is different, selecting an object from a group of objects which is most similar to a given object, selecting two objects in a group of objects that are most similar, finding a given object in a scene, counting the number of instances of an object in a scheme and object based analogies.

### RELATED APPLICATIONS

The present application claims priority under 35 U.S.C. §119 to U.S. Patent Application Ser. No. 61/249,567, filed on Oct. 7, 2009, entitled “Systems and Methods for Protecting Websites from Automated Processes Using Visually-Based Children's Cognitive Tests” which is incorporated by reference in its entirety.

### BACKGROUND OF THE INVENTION

1. Field of the Inventions

The invention relates to human challenges also referred to as reverse Turing tests and specifically to the use of visually-based children's cognitive tests.

2. Background Information

One important aspect of online security is to require human interactions. There are many applications where human access is allowed, but automated access is forbidden or discouraged. Generally, this is either to prevent overburdening a system such as the United States Patent and Trademark Office's (USPTO) own Patent Application Information Retrieval (PAIR) system, to limit access such as a ticket reseller who wants to prevent bulk buying and scalping of tickets, or to prevent robots from accessing a website.

Generally, the approach taken is to provide a problem that is easily solved by a human but difficult to solve by a computer. It is well known that visual recognition is a generally difficult problem for a computer, but often easy for a human. A vast majority of human challenges used by websites discourages automated access by using text recognition. When a user requests access to a protected part of a website a graphic image is displayed showing some text, in some cases it might be words or at other times it might be random characters or numbers. In order to defeat simple optical character recognition (OCR) systems, the graphic is obfuscated or distorted. For example, the font and size of the characters are varied. Lines and noise are sometimes added to the graphic to further obscure the text.

FIGS. 1A, 1B and 1C illustrates actual challenges taken from several websites. FIG. 1A was taken from a ticket sales site. FIG. 1B was taken from the USPTO's PAIR website. FIG. 1C was taken from the European Patent Office's espacenet website. In addition to text present in the graphic shown in FIG. 1A, the word “RETAIL” has added lines. The difficulty with reading this example is that it is unclear whether the last letter is actually an “L.” The readability issue is further illustrated in FIG. 1B, in the PAIR graphic example, it is unclear if the first word actually begins with the letter “B” or the number “13.” It is unclear what letter follows the parenthesis. The second word has noise added as well and may be of a different font. FIG. 1C illustrates a graphic displaying only numbers. The numbers are slightly tilted and vary in size. This example subjectively appears easier to read, but due to the clarity of the characters and the limited set of characters, i.e., only numeric digits, it is also more easily read by a computer.

The general difficulty with text recognition challenges is that OCR systems have developed to such a degree that they are designed to read poorly written text and text in a noisy environment. While OCR development efforts are not designed to thwart text recognition challenges, as OCR systems become more sophisticated, the text recognition challenge systems will have to further obfuscate the text in the images. In fact, according to some subjective criteria, the recognition of text by OCR systems can approach or surpass human abilities. If text recognition challenge systems continue to obscure the text even more, the challenge graphics will become totally incomprehensible.

Another approach disclosed by Lamberton, et al., in U.S. Pat. No. 7,373,510, the disclosure of which is incorporated by reference herein in its entirety, is to use graphic images accompanied by a “quiz” or instructions. While Lamberton suggests the use of graphics with a quiz, the patent fails to describe specifically how quizzes can be generated in a way to make it difficult to for an automated process. For example, if only a finite number of quizzes are stored, a human can answer the finite number of quizzes and instruct the attacking robot what the answers to the various quizzes are. The examples in Lamberton suggest that each website maintains a single, but carefully chosen challenge. A single challenge does satisfy the objective of keeping robots from accessing the protected web page. However, such a challenge would not necessarily preclude an automated process from accessing the same website such as a ticket sale site. Once all the quiz answers are known, the automated process can access the website at will.

Text challenges have the advantage that there is virtually an infinite selection of challenges available, but do have the drawback of evolving to the point where they keep many human users out. In contrast, quiz challenges such as Lamberton are confined to a small set of challenges limiting the protection from automated processes in many circumstances.

### SUMMARY OF INVENTION

Visually based children's cognitive tests can be used as a human challenge or reverse Turing test to verify that a human and not an automated process is operating a particular system, for accessing a restricted resource such as searching a database, purchasing tickets, downloading files, accessing a database, or requesting a reprieve from an anti-spam system.

The cognitive tests can be built from an image database, which can comprise the image representation of an object, an image mask associated with the objects, a hot zone, a hit mask and either keywords or object classes. One embodiment uses biological taxonomy to define classes. Based on the image database, several different visually oriented cognitive tests can be derived, for example, selecting one object in a group of objects that is different, selecting an object from a group of objects which is most similar to a given object, selecting two objects in a group of objects that are most similar, finding a given object in a scene, counting the number of instances of an object in a scheme and object based analogies. Alternatively, vector graphics can be used instead of images.

A wide variety of visually-based children's cognitive tests can be used including, but not limited to the “which one of these is not like the others” (WOOTINLTO) cognitive test, where a user is asked to identify an object that is not like another, the similar object cognitive test where a user is asked to pick an object which is most similar to a given object, the two similar objects cognitive test, where a user is asked to pick the two objects out of a panel of objects which are most similar, the find the object cognitive test where a user is asked to point to a given object, the count the object cognitive test where the user is asked to count the number of a given object in a scene, the visual analogy cognitive test where the user is asked to complete an analogy based on given images, and the rhyming match cognitive test where the user is asked to select an image which rhymes with a given image.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A, 1B and 1C illustrates actual challenges taken from several websites;

FIG. 2 illustrates a WOOTINLTO cognitive test;

FIG. 3 illustrates another challenge using the WOOTINLTO cognitive test;

FIG. 4 illustrates an exemplary embodiment of a system to generate a number of different types of visual children's cognitive tests;

FIG. 5 is a flowchart showing the steps used to generate a WOOTINLTO cognitive test;

FIGS. 6A and 6B show simple examples of occlusion, a car hidden behind a pole and a giant panda partially hidden behind some bamboo;

FIG. 7A shows an unoccluded car;

FIG. 7B shows is the pole which is a scenery object in this case;

FIG. 7C is the extent of the pole defined by the cross hatched mask;

FIG. 7D shows an example of a hot zone of a car which is the entire car;

FIG. 7E shows an example of a hot zone of a car which is the front of the car;

FIG. 8A shows an unoccluded picture of a giant panda;

FIG. 8B shows an example of a hot zone of the giant panda which is its face;

FIG. 9 illustrates a similar objects cognitive test;

FIG. 10 shows a flow chart for implementing the similar objects cognitive test;

FIG. 11 illustrates a two similar objects cognitive test;

FIG. 12 shows a flow chart for implementing the two similar objects cognitive test;

FIG. 13 shows a “find the object” cognitive test;

FIG. 14 shows a hit mask related to the giant panda in the scene;

FIG. 15 shows a counting objects cognitive test;

FIG. 16 shows a flowchart illustrating how to construct the finding an object challenge and the counting objects challenge;

FIG. 17 shows a visual analogy cognitive test;

FIG. 18 shows a flow chart showing how to construct a visual analogy cognitive test;

FIG. 19 shows a rhyming match cognitive test;

FIG. 20 shows a flow chart showing how to construct a rhyming match cognitive test;

FIG. 21 shows an embodiment of a web server implementing the visually-based children's cognitive test;

FIG. 22 shows an exemplary web interface for a ticket sale;

FIG. 23 shows an exemplary web interface for a blog posting;

FIG. 24 shows an embodiment of an anti-spam system using a visually-based children's cognitive test challenge; and

FIG. 25 shows an exemplary user interface offered by the system in FIG. 24 where the challenge is a WOOTINLTO challenge.

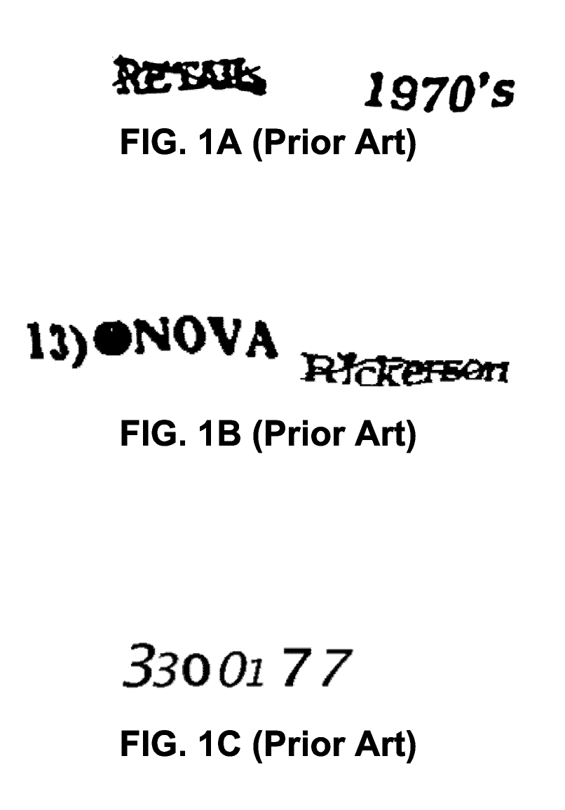

### DETAILED DESCRIPTION

A detailed description of embodiments of the present invention is presented below. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

The ability of humans to analyze images and images with abstract concepts is acquired even in early childhood, whereas this ability is still considered a difficult problem for machines. This is evidenced by cognitive tests given to children as educational entertainment and learning. Because most children can identify images and objects far more rapidly than they develop language skills, cognitive tests can be used to help distinguish humans from machines on a website. Generally, a visually-based children's cognitive test can be any form of basic test that incorporates the ability to recognize various objects as part of finding the solution to a test. Many embodiments are described herein.

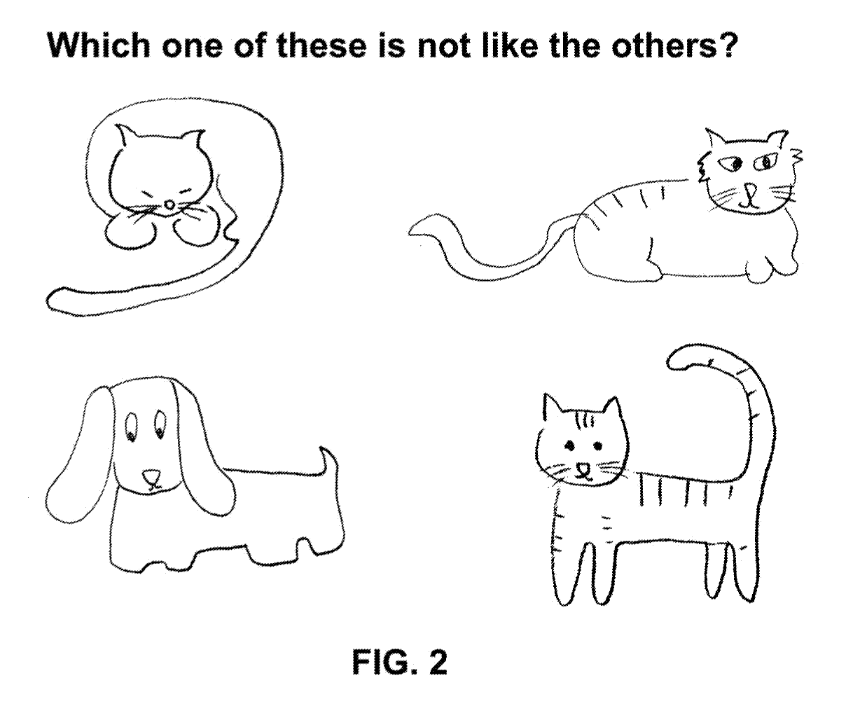

FIG. 2 illustrates a cognitive test similar to those many of us may recognize from childhood. In this particular embodiment, four images are displayed. The subject is asked a simple question, “Which one of these is not like the others?” The test shows three cats and one dog. Even the youngest children can correctly identify the dog as being different. However, for a machine to make the correct choice, the machine has to determine that all images are not only animals, but what type of animal. Beyond that the machine must also know that a dog is not a cat.

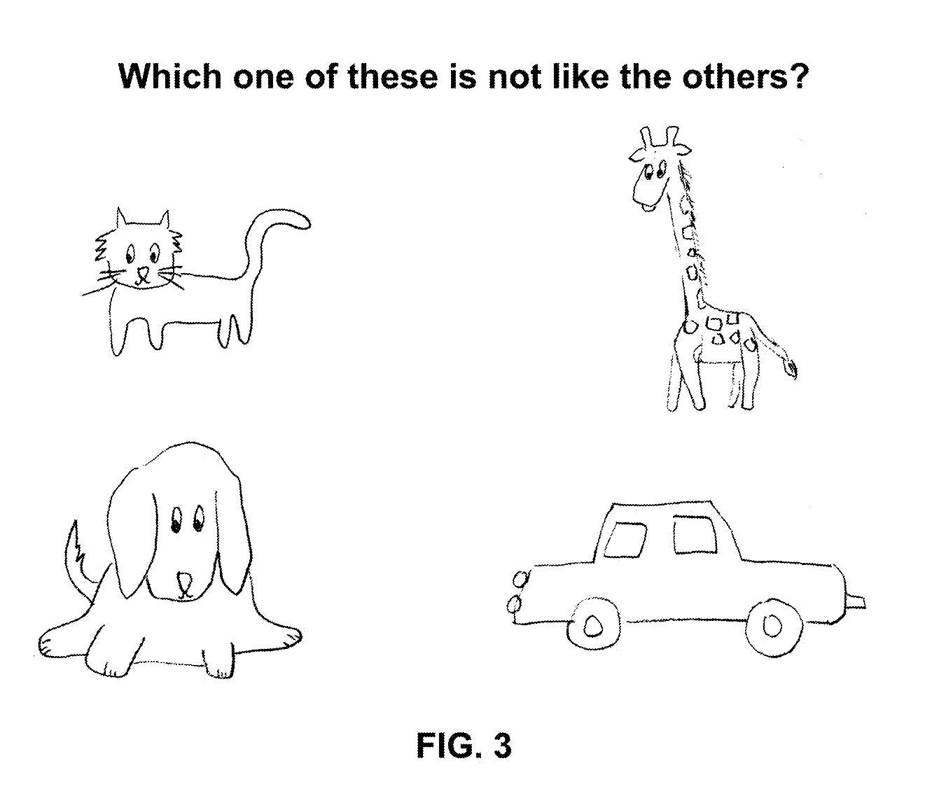

To avoid the vulnerabilities of a finite quiz set, a new challenge can be issued incorporating a different concept. For example, rather than selecting a dog out of a set of cats (i.e., species identification) the new challenge could ask the user to distinguish animal from non-animal. Specifically, FIG. 3 illustrates another challenge using the “which one of these is not like the others” (WOOTINLTO) test. In this example, a dog, a cat, a giraffe, and a car are displayed. Now in addition to identifying the type of object, the fact that a car is not an animal must also be known by the machine.

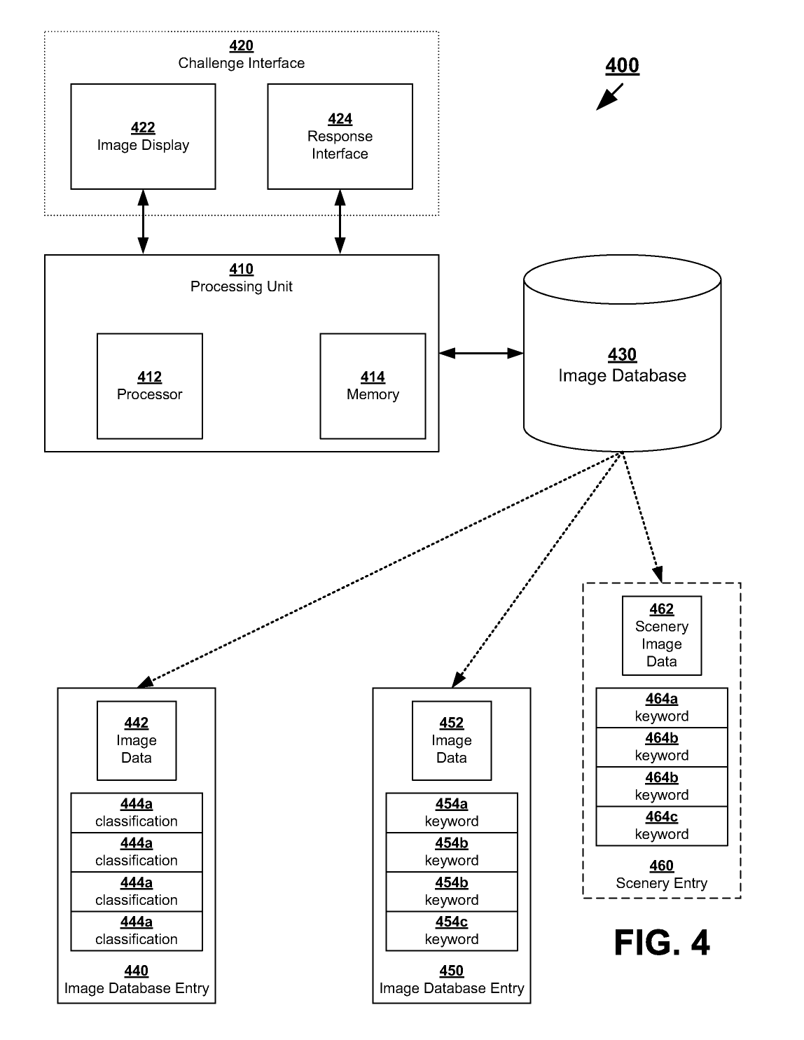

In order to construct a combinatorially large number of challenges, a classification system along with a collection of images should be used. FIG. 4 illustrates an exemplary embodiment of a system to generate a number of different types of visually-based children's cognitive tests. System 400 comprises processing unit 410, which can by any type of processing unit conventionally used. In this example, processing unit 410 is shown as comprising processor 412 and memory 414 used to store program instructions for processor 412. Memory 414 can also store data. System 400 further comprises challenge interface 420, which causes the challenge to be displayed through display interface 422 and received through response interface 424. In the case of protecting a website, the display interface and response interface can be a network interface and/or web server which can communicate with a remote user's computer through a web browser. System 400 further comprises image database 430.

Each entry into an image database contains image data, which comprises at a minimum an image representation of an object. It may further contain information such as one or more masks and a hot zone. A mask in general is used to indicate the extent of an object within image. For instance, most objects have an irregular shape (e.g., the human head is generally oval shaped but with protrusions such as ears), but most image representations are in a rectangle. An example of a mask would be a representation that defines the boundaries of an object within an image. The hot zone of an object in an image representation is a minimum region required for a reasonable human to still recognize the image. For example, if the object is a cat, the hot zone might be the head as a cat might be recognizable from the eyes, ears and nose without the need to view the entire body. Both the mask and the hot zone can be useful for constructing scenes in the challenges described below.

Image database entry 440 is one variation on an image database entry. In addition to image data 442, which is essentially the same as image data described above, image database entry 440 comprises a plurality of classes (444a-d). Each class represents some sort of organization of the images. The stricter the membership into a class the better the challenges produced will be. For example, one form of classification is to apply biological taxonomy to define the various classes an image belongs to. A cat would then be in the animalia kingdom, the chordata phylum, the mammalia taxonomic class (this is not to be confused with the word “class” as used in this disclosure) the carnivora order, the felidae family, the felis genus, and the felis catus species. A dog would be in the animalia kingdom, the chordata phylum, the mammalia taxonomic class, the carnivora order, the canidae family, the canis genus, and the canis lupus species. So for biological objects in particular animals, which are much more distinguishable by the average human than plants, using taxonomic classification can yield a wide variety of challenges. For example, in FIG. 2 rather than using 3 “fells catus” images, other animals belonging to the felidae could be used without making the challenge significantly harder for the human. Such a challenge could include a jaguar and a puma alongside a house cat with a dog still being the object that is different. The use of classes derived from biological taxonomy has the advantage that objects are guaranteed to belong to a single taxonomic rank.

Image database entry 450 is another variation of an image database entry. In addition to image data 452, which is essentially the same as image data described above, image database entry 450 comprises a plurality of keywords (454a-d). Unlike the use of classes, the use of keywords is less strict. Again, an image relating to a cat can include keywords such as “cat,” “feline,” “quadruped,” etc., some of which may end up being equivalent to the taxonomic classification. However, keywords allow for flexibility in adding additional distinctions. For example, the cat's action could be added, such as “meowing,” “hissing,” “standing-up,” “clawing,” etc. Extra care should be taken when simply using keywords. For example, keywords often introduce gray areas, if color is added as a keyword a maroon color car might have the keyword “maroon,” but the existence of the maroon keyword does not necessarily rule out “red.” A WOOTINLTO challenge could display a red car, a maroon car, a red truck and a red car. Using keywords, the challenge system may have ascribed the keyword “red” to the two red cars and red truck, but selected the maroon car because it was absent the keyword red. However, to the end user the maroon car may appear simply to be a darker red and selects the red truck since it is a different type of vehicle. However, this can be addressed by simply allowing the user to request a new challenge if the challenge is too ambiguous. So with carefully chosen keywords, the image database can use a keyword system rather than a strict classification system.

Image database 430 can comprise another type of entry, shown here as scenery entry 460. Scenery entry 460 comprises scenery image data 462 which is similar to the image data described previously except the image represents scenery objects which are not used in the challenge by themselves. Most likely, the scenery image data comprises at least one mask defining the boundaries of the scenery objects. However, since the purpose as described later is for building a scene and not needed for identification, no hot zone needs to be defined. Optionally, the scenery entry can comprise keywords (e.g., 464a-d). The keywords in this case are used in accordance with a theme related to an object for which the scene is built. For example, if a WOOTINLTO challenge uses only animals, and if a farm animal is to be depicted, the scenery can be selected from a collection of farm imagery by selecting scenery images having the “farm” keyword.

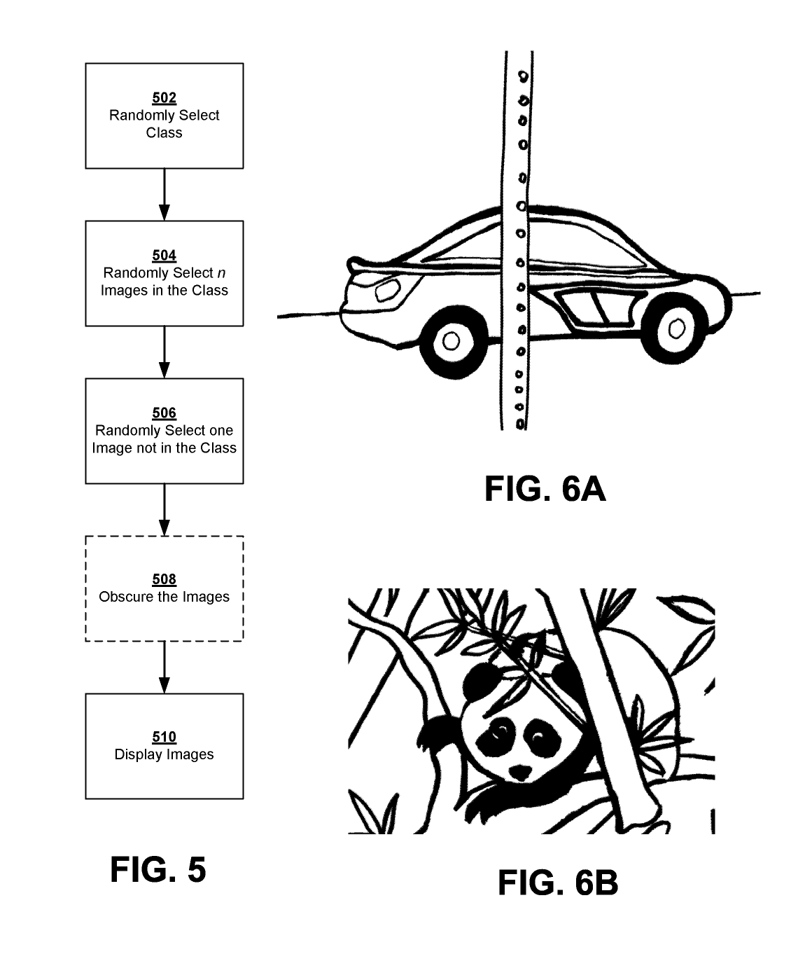

FIG. 5 is a flowchart showing the steps used to generate a WOOTINLTO challenge. At step 502, a class is randomly selected. At step 504, n random images belonging to that class are selected, where the WOOTINLTO challenge displays n+1 images. At step 506, one image not belonging to that class is selected. At step 508, optionally, the images are obscured. At step 510, the n+1 images are displayed in a random order. The user can successfully solve the challenge by selecting the image selected at step 506. While this example and the ones to follow use classes within a classification, the use of keywords can be substituted. For example, at step 502 a keyword is randomly selected; at step 504 n random images having the selected keyword are chosen; and at step 506, one image not having the selected keyword is selected. It should be understood that the selection of images based on keywords can be substituted for the selection of images based on classes in this and the other challenges described below.

At step 508, the image can be obscured to make it more difficult for an automated system to eventually learn the challenges posed by the system. Simple methods of obscuring images include distortion (e.g., barrel distortion and pin-cushion distortion), blurring (e.g., Gaussian blurring and motion blurring), scaling, skewing, rotating and the addition of noise. In addition, occlusion can be used to further obscure an image. While techniques such as distortion and blurring can obscure an image somewhat from an automated system while not complicating the problem for a human, dealing with occlusion is a very difficult problem in machine vision. Simply put, occlusion is the hiding of part of the image representation of an object by placing another object in front.

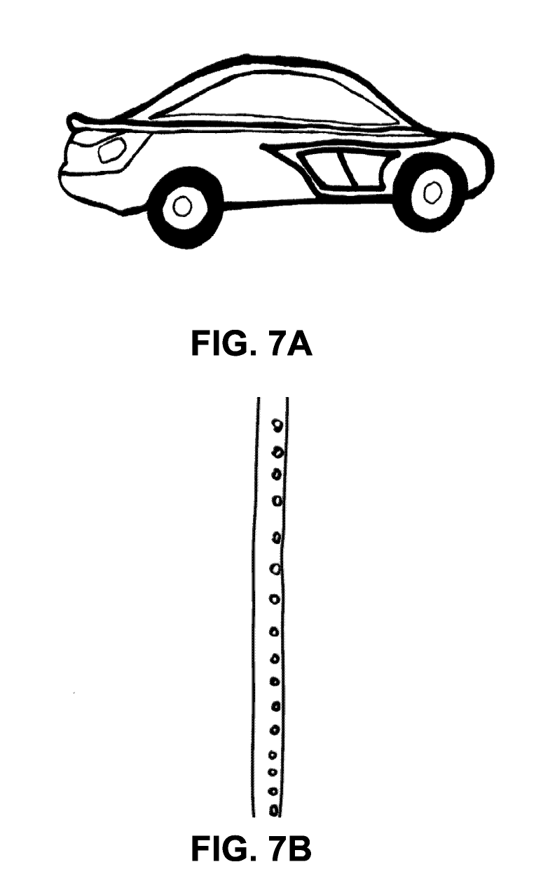

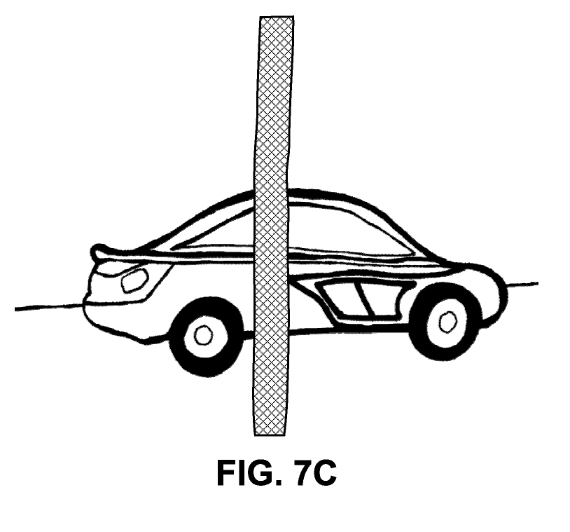

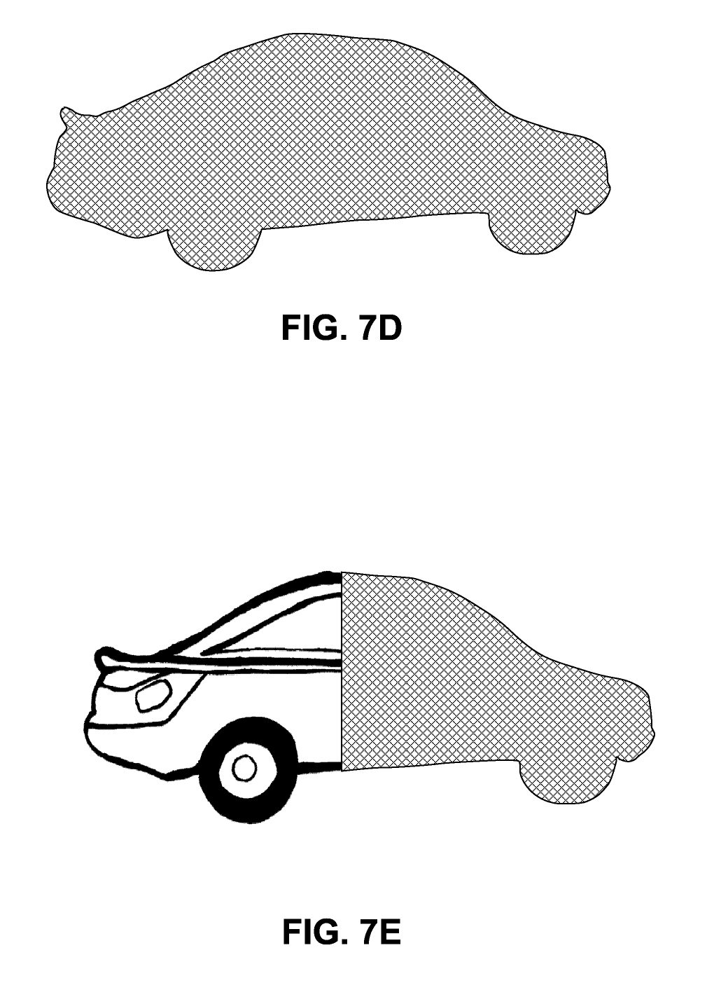

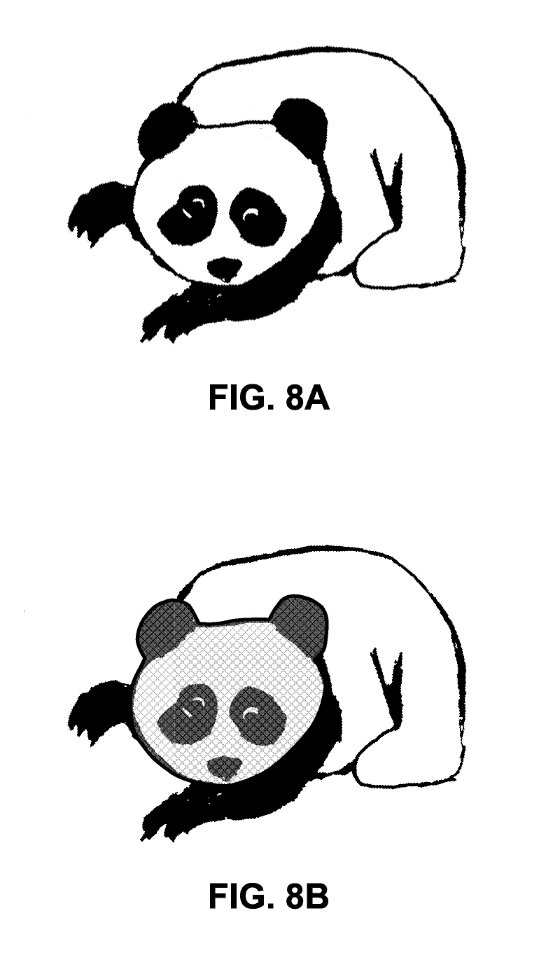

FIGS. 6A and 6B show a simple example of occlusion. FIG. 6A shows a car hidden behind a pole. FIG. 6B shows a giant panda partially hidden behind some bamboo. In constructing an occluded image, scenery objects are overlaid on top of the image being occluded. The extent of the scenery objects is defined by an image mask stored along with image representation. FIG. 7A shows an unoccluded car. FIG. 7B shows is the pole which is a scenery object in this case. FIG. 7C is the extent of the pole defined by the cross hatched mask. Though a subjective measure, the hot zone of the car could be the entire car as shown in FIG. 7D or it could be the front of the car as shown in FIG. 7E. In the second example, FIG. 8A shows an unoccluded picture of a giant panda. In this case, the hot zone as shown in FIG. 8B could be defined to be the panda's face as it is one of the most recognizable feature of a giant panda.

When overlaying the scenery objects, the hot zone of the underlying object should not be occluded or minimally occluded. In one embodiment, there could be a tolerance associated with occlusion of the hot zone. If the hot zone of the giant panda is its face and the occlusion process could be restricted to only permit the face up to be occluded at most by 5%. As shown in FIG. 6B, the giant panda's face is partially occluded by a bamboo leaf. This tolerance can be a predetermined tolerance set for the challenge system or a tolerance specific to each object. Many scenery objects can be added, but should be limited. If too many scenery objects are added it may appear that the scenery object and not the underlying object are the subject of the challenge. For example, if trees are added to an image of a wolf, there comes a point where the user would wonder if the image is that of a wolf or of a forest with the wolf as scenery.

If both image transformations such as distortion and blurring are used in conjunction with occlusion, building the occluded image prior to applying image transformation is more efficient.

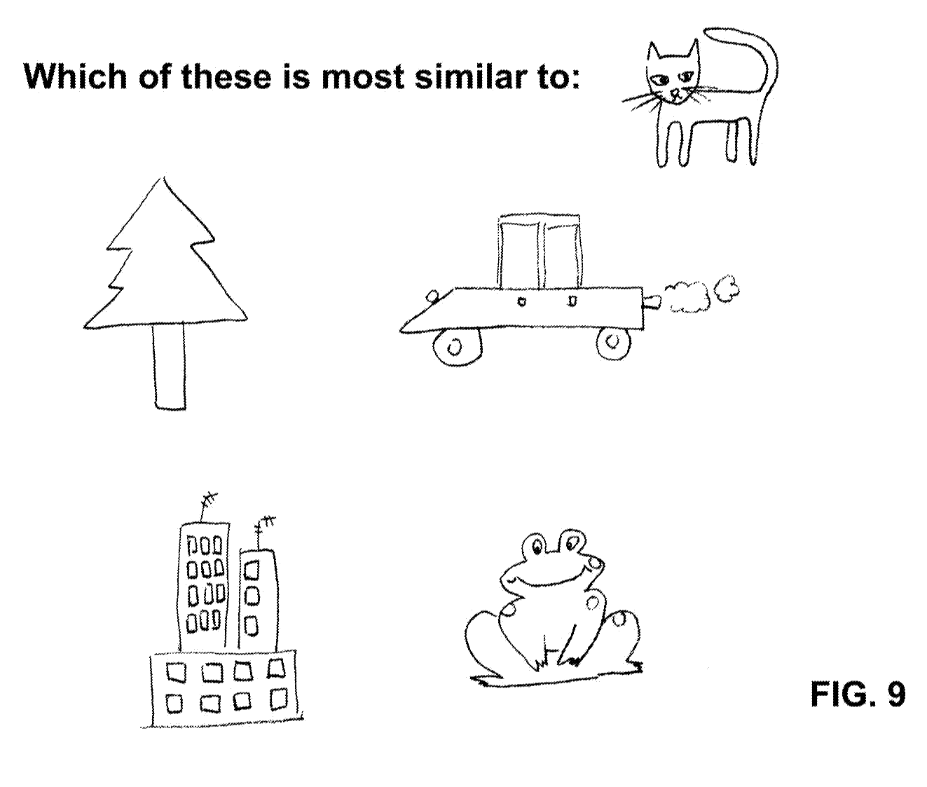

FIG. 9 shows another challenge based on a visually-based children's cognitive test. In the similar objects cognitive test, the user is asked to identify the object that is most similar to the indicated object. In this case, the indicated object is a cat. Among the challenge choices are a tree, a car, a building and a frog. The frog is most similar to the cat because they are both animals whereas two objects are not alive and the third is a plant. While this is still a subjective test (one could argue, the cat is most similar to the car because their English spellings are different by only a letter), the vast majority of people would select the frog.

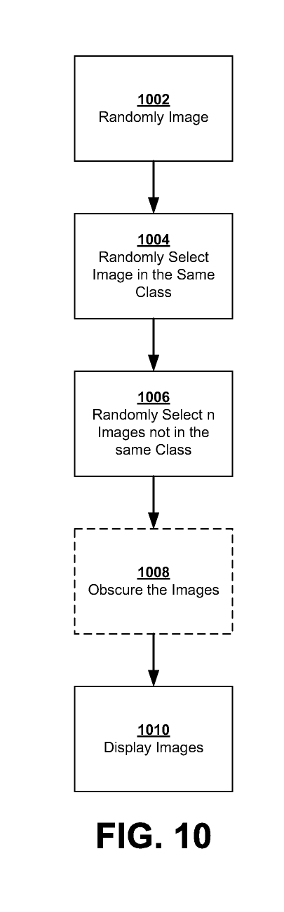

FIG. 10 shows a flow chart for implementing the similar objects cognitive test. At step 1002, an image is randomly selected. At step 1004, an image belonging to the same class as the selected image is selected. This image represents the solution to the challenge. At step 1006, n random images are selected that do not belong to the same class as the selected images. At step 1008, the images are optionally obscured. At step 1010, the images are displayed in the challenge. The image selected at step 1002 is placed next to the indicator text and the images selected in step 1004 and step 1006 are randomly placed as choices for the user. The selection of the image shown in step 1004 solves the challenge.

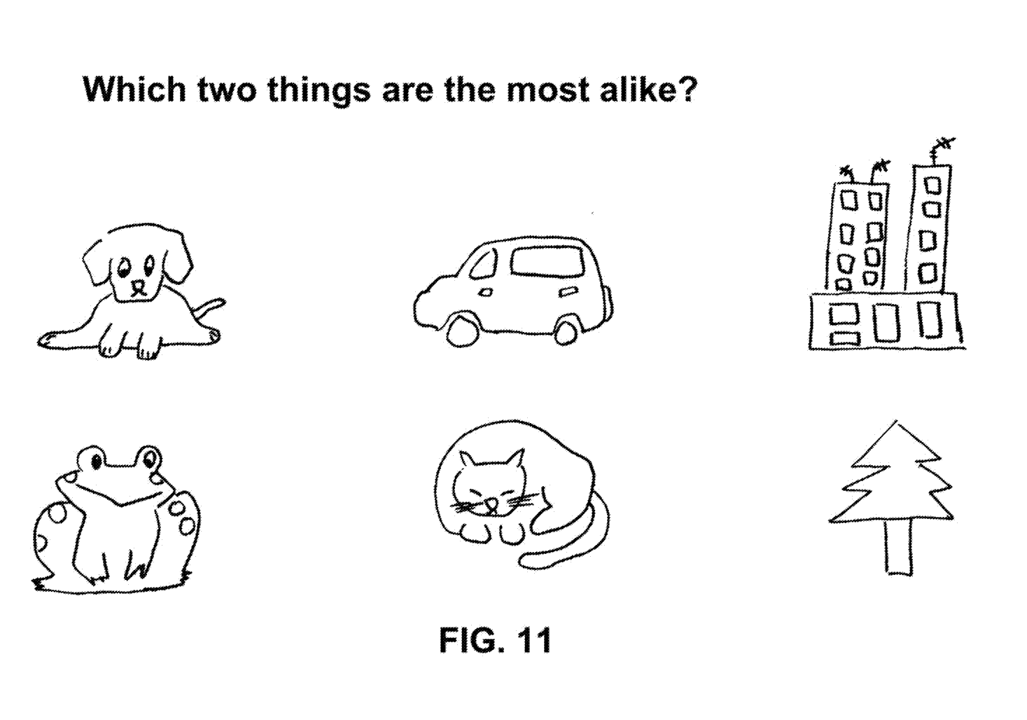

FIG. 11 shows another challenge based on a visually-based children's cognitive test, the two similar objects cognitive test. The challenge is to select the two objects out of a field of objects that are most similar. Shown in this challenge are a dog, a car, a building, a frog, a cat, and a tree. This challenge is likely to be the most difficult for an automated system, but it also can lead to additional ambiguity to the human. The solution sought in this challenge is the dog and cat because they are both mammals; in fact, both belong to the order carnivora. However, a reasonable case can be made that the car and building are most similar since they are both non-living objects or the tree and the building since they are both non-moving objects. However it is not necessary that a very clear solution is available every time as long as the user is allowed to request another challenge.

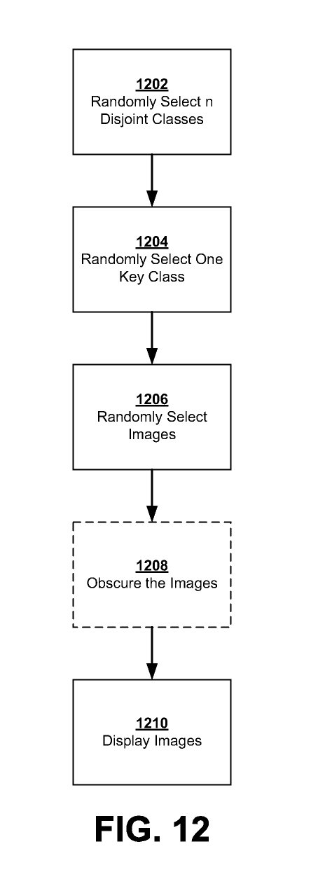

FIG. 12 shows a flow chart for implementing the two similar objects cognitive test. At step 1202, n mutually disjoint classes are selected. At step 1204, one of these classes is selected as the key class. At step 1206, two images in the key class are selected and one image from each of the other classes is selected. At step 1208, the images are optionally obscured. At step 1210, the images are displayed in a random order. The user can solve the challenge by selecting the two images belonging to the key class.

Thus far the cognitive tests rely on the user being able to make an approximate identification of objects (A user need not necessarily be able to distinguish a jaguar from a puma for example.) and to associate objects based on a general sense of classification. One advantage of the preceding challenge is that there is very little need for language skills, if any. It may be possible that even if no instructions were given the average user could probably deduce the objective of the WOOTINLTO challenge or the two similar objects challenge.

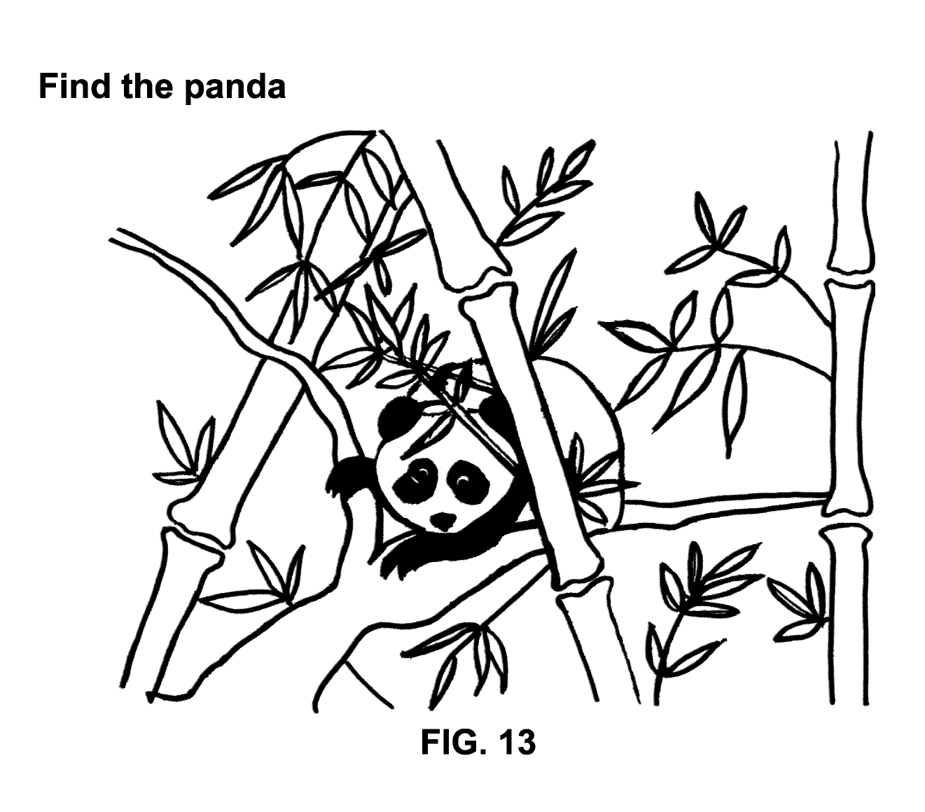

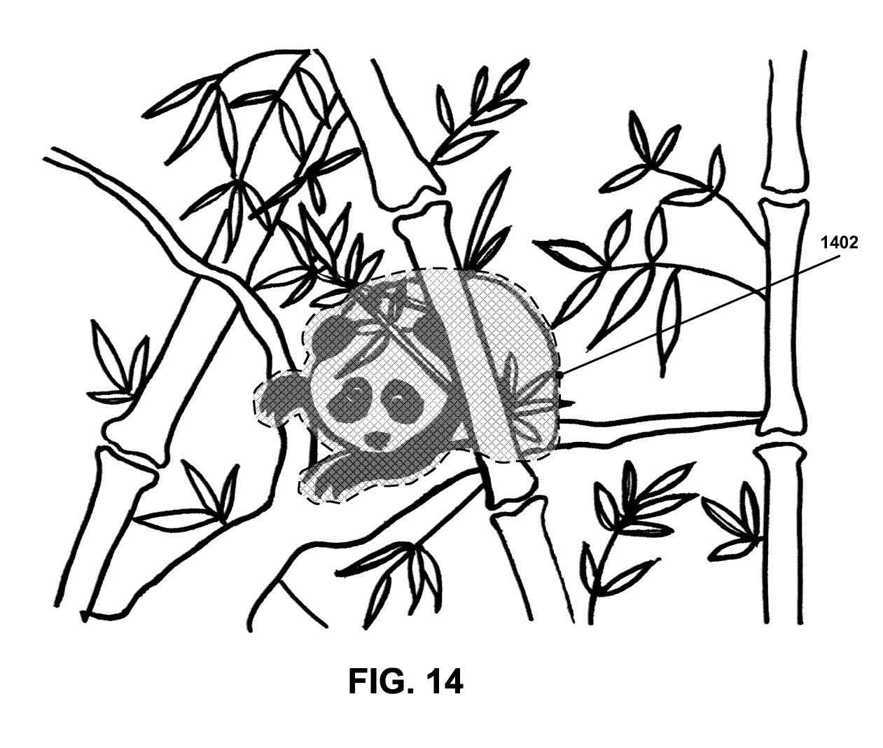

Another set of challenges that can be constructed from children's cognitive tests involves additional language skills and rely on identifying objects based on a description. FIG. 13 illustrates one of the simplest embodiments of these types of challenges. The objective of the challenge is to locate an object in a scene. Specifically, the user is asked to find the giant panda in the scene. Unlike the previous visual challenges, where the user can simply click a button representing a choice or click on a choice of images, the user must specify a location within an image. Therefore, underlying the image provided to the user as a challenge is a “hit mask.” The hit mask shows the extent of the actual object. It can allow a certain degree of error, that is, the hit mask can extend slightly beyond the object. FIG. 14 shows a hit mask related to the giant panda in the scene. Hit mask 1402 as shown is slightly larger than the giant panda and encompasses some of the scenery. This choice of hit mask provides a reasonably forgiving response area. If the user clicks anywhere within hit mask 1402, the challenge is correctly solved.

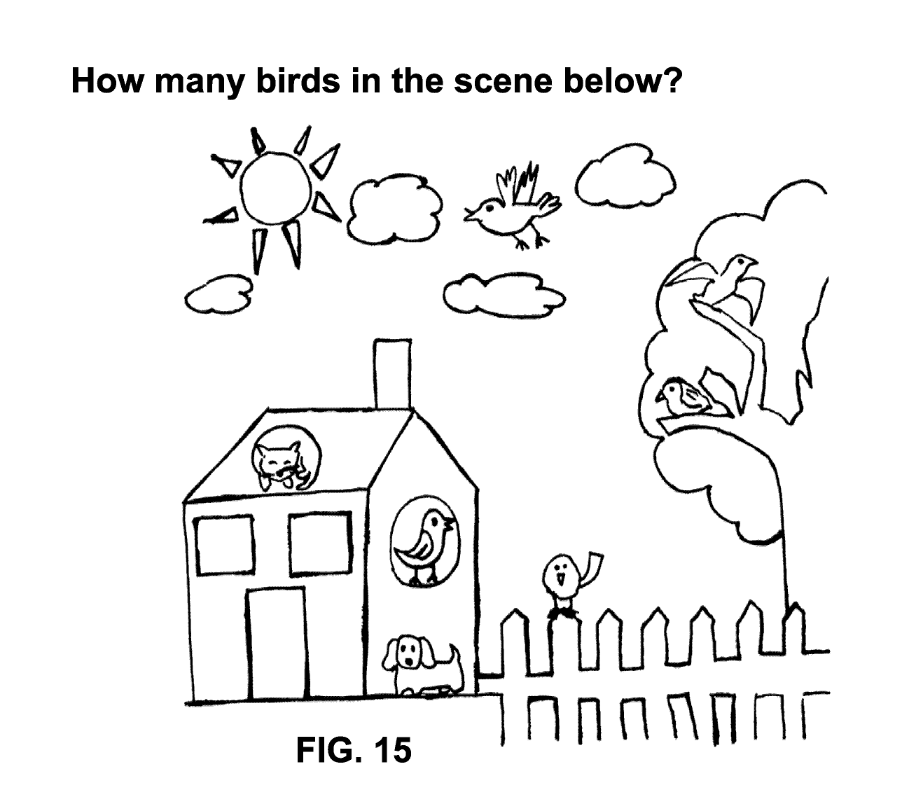

Another variation of object recognition type of challenge is to identify the number of a particular object in a scene. FIG. 15 shows a challenge where the objective is to count the number of birds in a scene. Both this challenge and that depicted in FIG. 13 require the user to understand what the object is and to associate an image with the object. This type of challenge accepts a numeric input rather than a click location as an input as in find the object challenge.

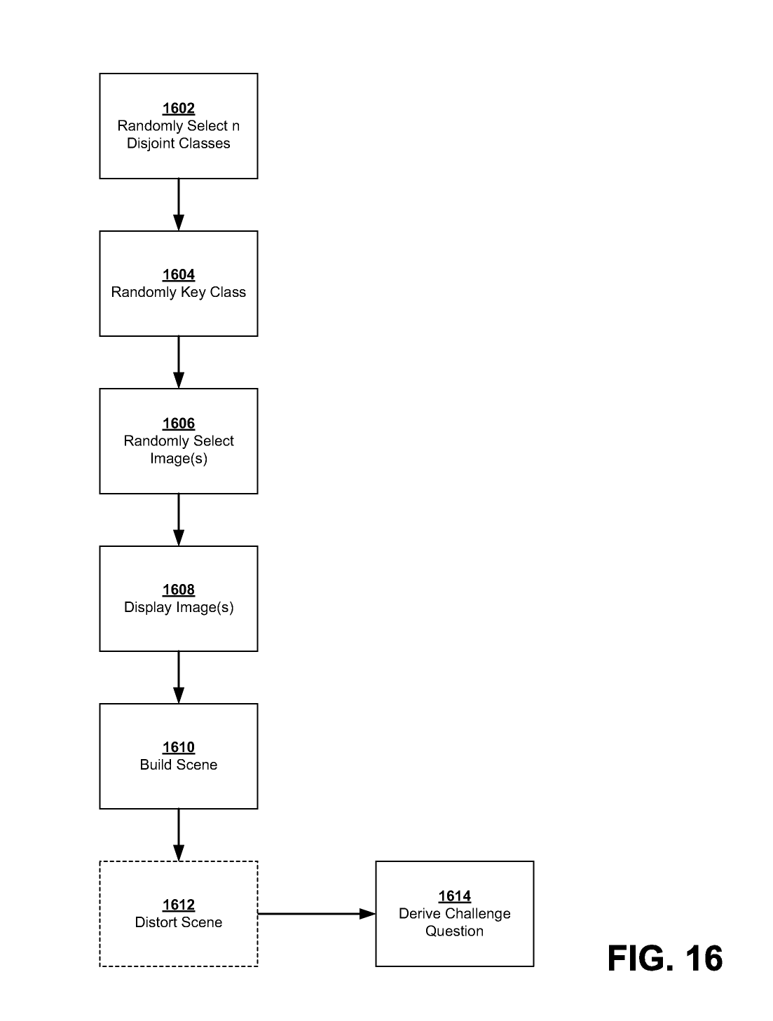

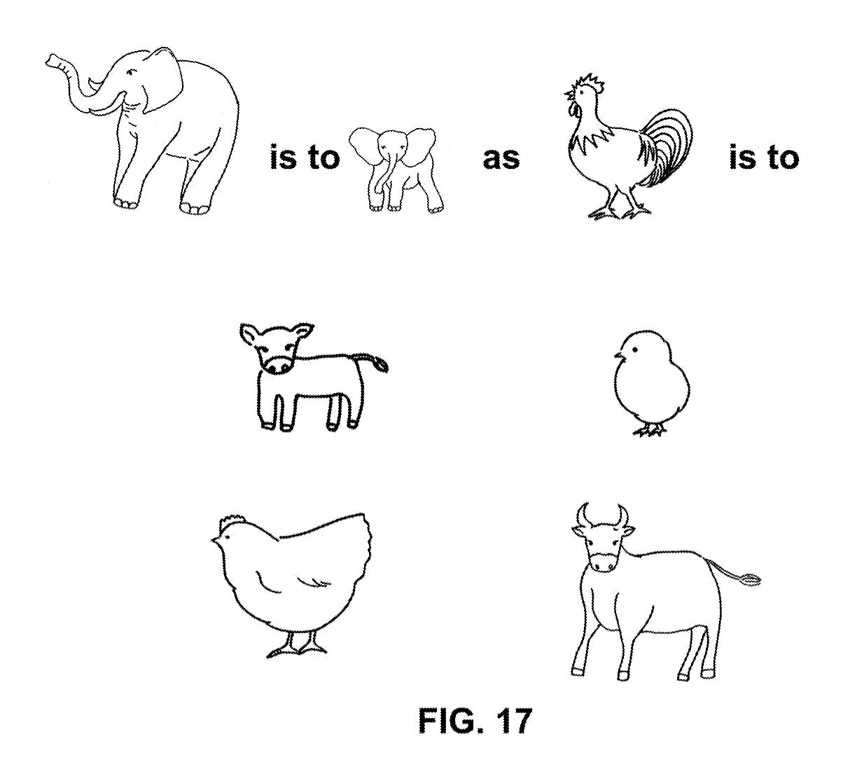

FIG. 16 shows a flowchart illustrating how to construct the finding an object challenge and the counting objects challenge shown in FIGS. 13 and 15, respectively. For the sake of example, in discussing both tests, the images should be assumed to be taken from an animal image database using biological taxonomy. At step 1602, a key class is randomly selected. At step 1604, one or more images are selected in the key class. In the case of identifying a single object as in FIG. 13, one image is selected. In the case of counting objects as in FIG. 15, one or more images are selected. At step 1606, optionally, random images not in the key class are selected. For example, in FIG. 15 a cat and dog are included along with the birds in the scene. These images can be used to augment scenery images to build a complete scene. At step 1608, all the selected images are placed into a single output image. Care should be taken not to excessively occlude any object which is in the key class, where excessively occlude can be defined with the same criterion described above in the discussion of FIGS. 6A and 6B. At step 1610, scenery objects are added to the output image to complete the scene. For example, in FIG. 15, the sun, clouds, a house, a tree and a picket fence are added as scenery objects. At step 1612, optionally, the entire scene can be further distorted as described above. At step 1614, the challenge question is derived. At this point, the user is asked to either identify the named object or count the number of named objects. It should be noted that if taxonomic classifications are used, a lay term should be used. For example, rather than issuing the challenge “How many chordata are in the scene?” or “How many mammalia are in the scene?” the challenge “How many vertebrates are in the scene?” or “How many mammals are in the scene?” should be used instead. Unfortunately not all taxonomic classifications have lay terms, so some variations of these challenges are limited to those classifications with lay terms.

Another example of a visual children's cognitive test is to use analogies. FIG. 17 shows a visual analogy challenge. The challenge line shows an image of an adult elephant, an elephant calf and a rooster. The choices section show a bovine calf, a chick, a hen and a bull. The visual analogy challenge asks the user to fill in the analogy. In this case “an elephant is to an elephant calf as a rooster is to a ______.” The challenge is correctly addressed if the user selects the chick. In this particular example, the analogy selects compares an adult animal with a juvenile version of the same animal. In order to implement an analogy challenge, analogy properties should be added to each image's entry in the image database. For example, in an animal image database, the image could indicate whether an animal is an adult or a juvenile, whether a particular image is male or female, etc. Furthermore, some properties could have multiple valid values rather than simply the binary choices offered by maturity or gender as described previously. Images that don't clearly exhibit this property could simply have the tag omitted. As long as the database is rich with many images the number of properties does not need to be very large to support a diverse set of visual analogy challenges.

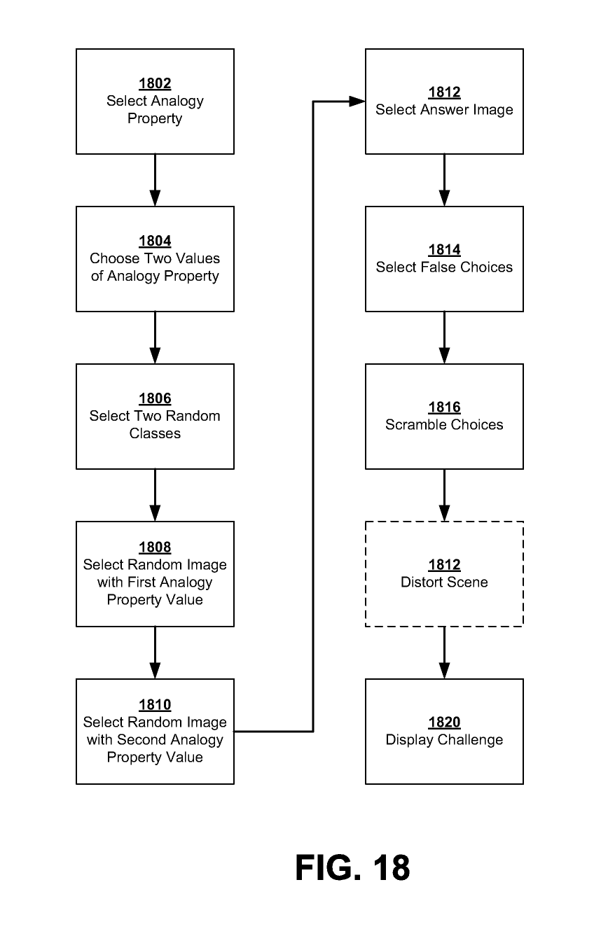

FIG. 18 shows a flow chart showing how to construct a visual analogy challenge. At step 1802, an analogy property is selected from the set of available analogy properties. At step 1804, two valid values for the analogy properties are selected, for example, adult and juvenile. At step 1806, two random classes are selected that have examples of both valid values selected at step 1804. At step 1808, a random image is selected in each of the two classes having the first of the valid values for the analogy property. At step 1810, a random image is selected in each of the two classes having the second of the valid values for the analogy property. At step 1812, one of the four images selected thus far is designated as the answer. At step 1814, false choices are selected which does not match either the class or the analogy property of the image selected in step 1814. At step 1816, the designated answer and the false choices are scrambled. At step 1818, the images are optionally obscured. At step 1820, the images are displayed in the challenge.

Using the specifics shown in FIG. 17, the steps are described in FIG. 18. At step 1802, animal maturity is selected as the analogy property. At step 1804, the values of adult and juvenile are selected. At step 1806, the random class of elephants and chickens (family Elephantidae and Phasianidae, respectively). At step 1808, images of an adult elephant and an adult chicken, (i.e., a rooster) are selected. At step 1810, images of a juvenile elephant and a juvenile chicken are selected. At step 1812, the juvenile chicken is designated as the answer. At step 1814, three more images are selected as false answer, none of which are juvenile chicken (chick). Specifically, the choices are a juvenile cow (bovine calf), an adult cow (bull) and an adult chicken (hen). It should be noted that some choices are juveniles, (e.g., a bovine calf) and some are chickens (e.g., the hen), but none have both the same analogy property (i.e., juvenile) and are from the same class (i.e., chicken). At step 1816, the image of the chick, hen, bull, and calf are scrambled.

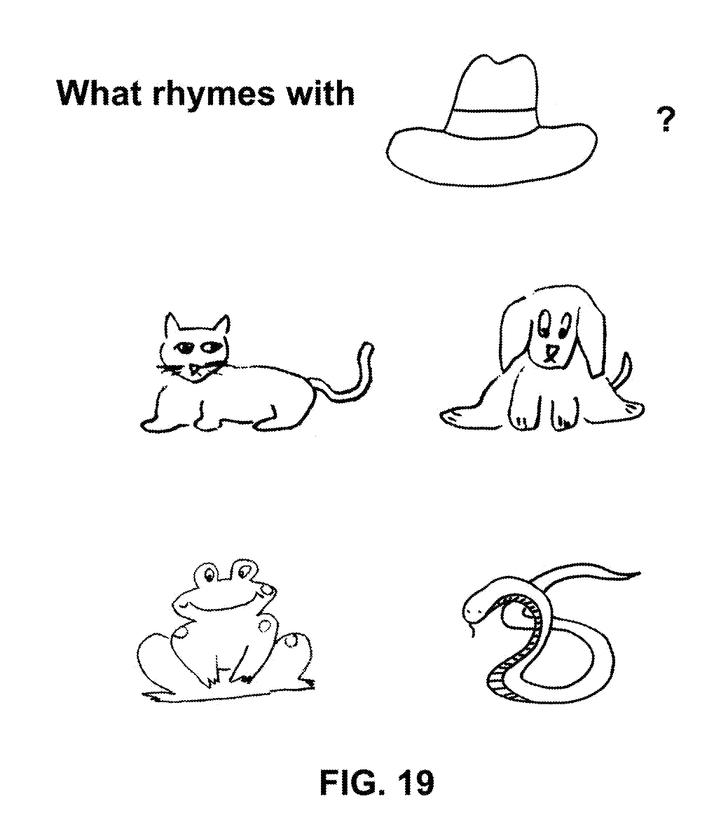

Another example of a visual children's cognitive test is to use rhymes. FIG. 19 shows a rhyming match challenge. The challenge asks the user to find an object which rhymes with the depicted image which in this case is a “hat.” The choices shown are a cat, a dog, a frog or a snake. Clearly, the solution to the challenge is the cat. This challenge can lead to an ambiguous solution. For example, if a mouse were depicted instead of a dog, confusion could arise because the mouse could be misinterpreted as a rat which also rhymes with a hat. Therefore, care should be taken when selecting the challenge. Once again, ambiguous challenges can be address by giving the end user the option to select a new challenge.

Images should include a list a synonyms and potentially phonetic spellings of each of the synonyms. This would enabled the challenge system to make accurate rhyme comparisons.

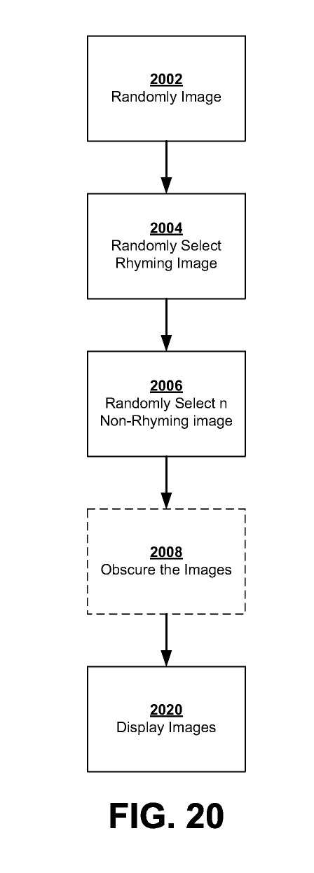

FIG. 20 shows a flow chart showing how to construct a rhyming match challenge. At step 2002, an image is randomly selected. At step 2004, an image which has a common name that rhymes with the most common name of the image selected in step 2002 should be selected. Although an obscure synonym may rhyme with the common image name selected in step 2002, such a match may not be that evident to the user. Likewise the common image name should be used in step 2002. The image selected in step 2004 represents the solution to the challenge. At step 2006, n random images are selected that do not rhyme with the selected images. To ensure an unambiguous test, each image should have all its synonyms tested so that no synonym rhymes with the selected images. At step 2008, the images are optionally obscured. At step 2010, the images are displayed in the challenge. The image selected at step 2002 is placed next to the indicator text and the images selected in step 2004 and step 2006 are randomly placed as choices for the user. The selection of the image shown in step 2004 solves the challenge.

Because the challenges described above can be built from the same image database, a challenge system does not need to be limited to one particular type of cognitive test. In fact, by rotating the challenge types, the rotation of challenges makes it more difficult for an automated system to solve the challenge.

Alternatively, vector graphics can be used in place of an image, so an object can be represented by a collection of drawing instructions. With vector graphics, coloring and shading can be varied for an object. In addition, the overlay of objects can easily be accomplished. Obscuring can be performed both before and after rendering of the vector graphic objects into an image. For example, it is easy to add distortions to vector graphics, but perhaps easier to add noise and blurring to an image.

The challenge systems disclosed above can be used to replace the text based “completely automated public Turing test to tell computers and humans apart” (CAPTCHA) challenges used by ticket sellers, patent offices and search engines.

Though there are many applications for this type of challenge system, one major application is in web pages such ticket sales, blog postings, etc. Referring to FIG. 4, the challenge interface is typically implemented with a web interface. The web pages are often generated by processing unit 410. The response to the challenge is often received through the web interface as well. In most implementations, the processing unit 410 provides the web pages, generates the challenge, and validates the challenge. Upon a successful response to the challenge, the processing unit permits the end user to access a restricted web service. In the case of a search engine (or patent office), a successful response to the challenge allows the end user access to a resource such as search results or database access. In the case of ticket sellers, blogs, etc., a successful response to the challenge allows the end user to complete a transaction, (e.g., purchase tickets, post on a blog).

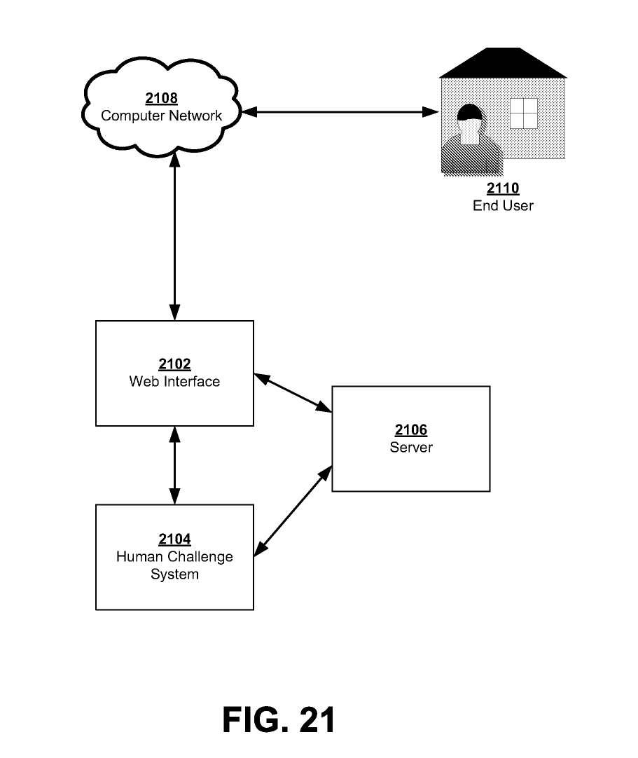

As an example, FIG. 21 shows an embodiment of a web server implementing the visual children's cognitive challenge. Functionally, the web server can comprise a web interface functional block, a human challenge system functional block and a central server. In practice, this may be part of the same hardware and even the same software. They are shown here separately for clarity. Upon end user 2110's request for a restricted resource such as a search request, post request, download request or transaction request, server 2106 receives a children's cognitive challenge from human challenge system 2104. Server 2106 can then generate a web page which contains a challenge and cause web interface 2102 to present the web page to end user 2110. The most common method is to transmit the web page over computer network 2108 to end user 2110 where end user 2110 can display it on his or her browser. End user 2110 answers the challenge which is received by web interface 2102. Server 2106 can either query human challenge system 2104 for validate or if server 2106 previously received the solution to the challenge, server 2106 can validate the solution. If the challenge is validated, server 2106 can release the restricted resource, such as providing a search result, access to completion of a transaction, or posting of a blog entry, etc. If the challenge was not successfully validated, other actions such as offering another challenge is performed.

It should be further noted that though the system is described specifically in terms of a web interface, the system can generically be described in terms of a generic challenge interface which can provide a challenge and receive a response from an end user.

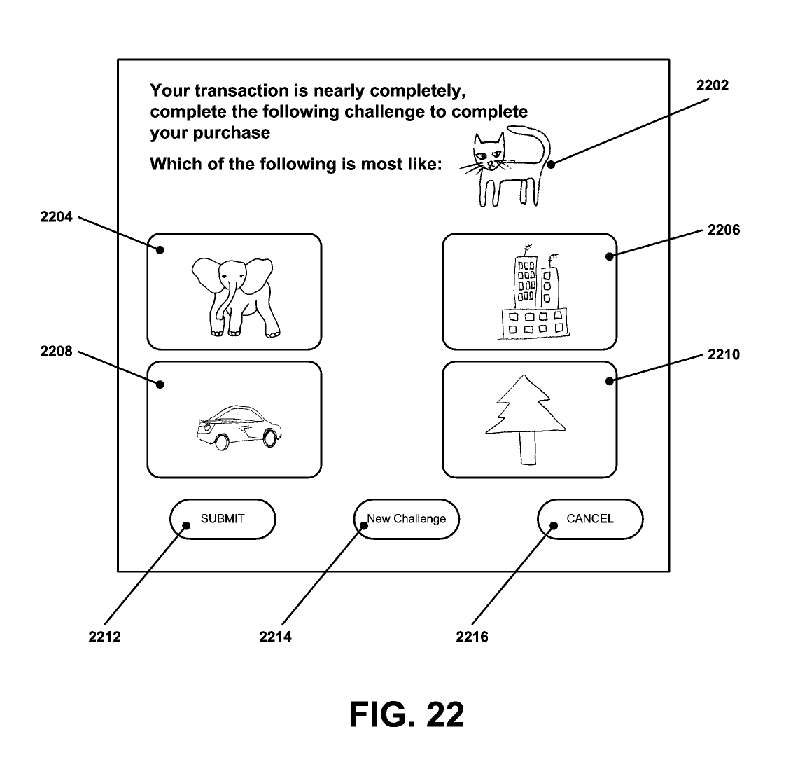

FIG. 22 shows an exemplary web interface for a ticket sale. In this particular example, the challenge is a similar object cognitive test. The displayed web page is an intermediary step where a user has already selected the tickets to purchase and is about to enter payment information. Images 2204, 2206, 2208, and 2210 are offered as choices. The user selects the image most similar to 2202. There are many standard methods of indicating the solution, such as with a graphic accompanied by a check box or as depicted here with graphic buttons. The action of the graphic buttons can also be varied. In one variant clicking on a button selects that box as a solution and is somehow highlighted. The sender can then press submit button 2212 when the choice is made. In another variant, there is no submit button and pressing a graphic button simultaneously selects the solution and submits the submission. In addition, there can be new challenge button 2214. If the sender presses new challenge button 2214, a new challenge is offered. This is useful in the event the sender does not understand the challenge. Optionally there can be other standard buttons often seen on webpage forms such as cancel button 2216, a reset button (not shown) and/or a help button (also not shown). In addition, the webpage can also offer an audio button (not shown) which can provide an audio cue to read out loud the objective of the challenge (e.g., “which of the following are most like the image to the right?”).

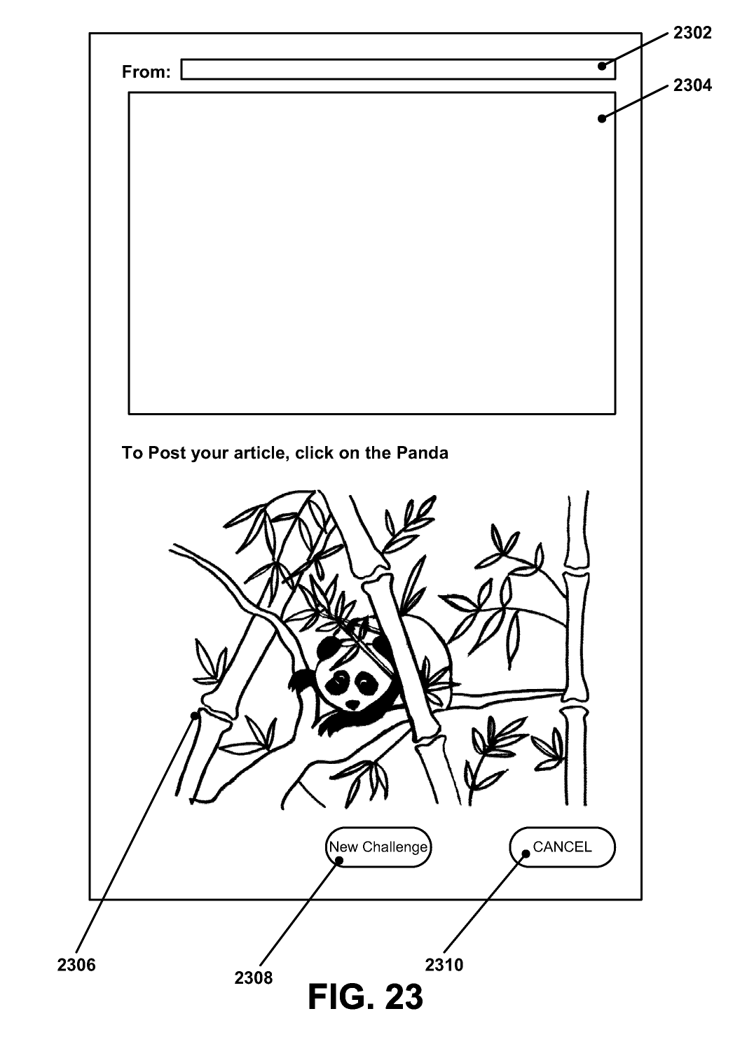

FIG. 23 shows an exemplary web interface for a blog posting. In this particular example, the challenge is a find the object cognitive test. The user can supply a handle in text field 2302 and the content of the desired posting in text field 2304. Image 2306 is offered as the find the object challenge. The user clicks on the specified object (i.e., the giant panda). If the user successfully clicks on the object, the article entered in field 2304 is posted on the blog. In addition, there can be new challenge button 2308. If the sender presses new challenge button 2308, a new challenge is offered. Optionally there can be other standard buttons often seen on webpage forms such as cancel button 2310, a reset button (not shown) and/or a help button (also not shown). In addition, the webpage can also offer an audio button (not shown).

In U.S. patent application Ser. No. 10/972,765, the disclosure of which is incorporated by reference herein in its entirety, an anti-spam appliance upon rejecting a message issues a passcode, which in one embodiment can be submitted by the sender in the subject line of a subsequent email to obtain a reprieve. This variation is vulnerable to a knowledgeable spammer system, which will simply read the passcode than automatically submit it again. However, instead a passcode can be issued that is submitted to a web interface. However, without some form of human challenge, a knowledgeable spammer system can also automatically submit the passcode.

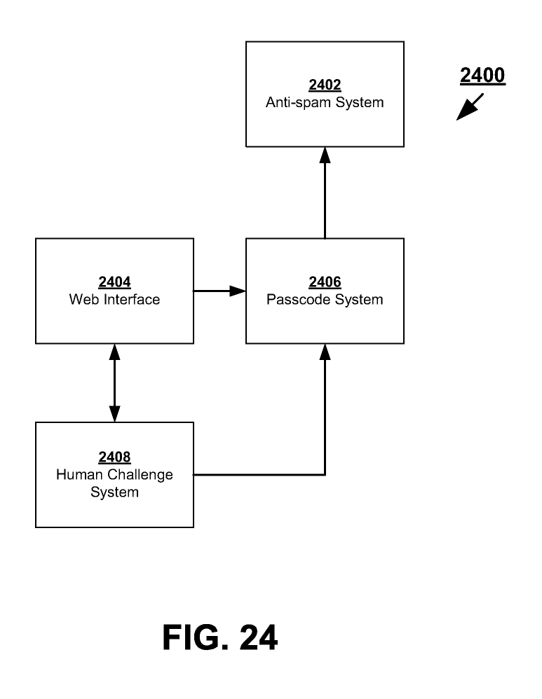

The system of FIG. 24 overcomes this problem by issuing a human challenge. System 2400 comprises core anti-spam system 2402, which can be the anti-spam appliance described in U.S. patent application Ser. No. 10/972,765. Web interface 2404 is offered to the sender for the submission of a passcode. Human challenge system 2408 such as the WOOTINLTO challenge issues the challenge through web interface 2404. Upon submission, the web interface delivers the challenge response to human challenge system 2408 and the passcode to passcode system 2406. Human challenge system 2408 determines whether the challenge is correct and reports the results to passcode system 2406. If the passcode is correct and the challenge is successfully answered, passcode system 2406 indicates that a reprieve should be granted to the sender by core anti-spam system 2402. While depicted functionally as separate modules, all the functional blocks shown in FIG. 24 could reside on the same hardware and even share the same processors.

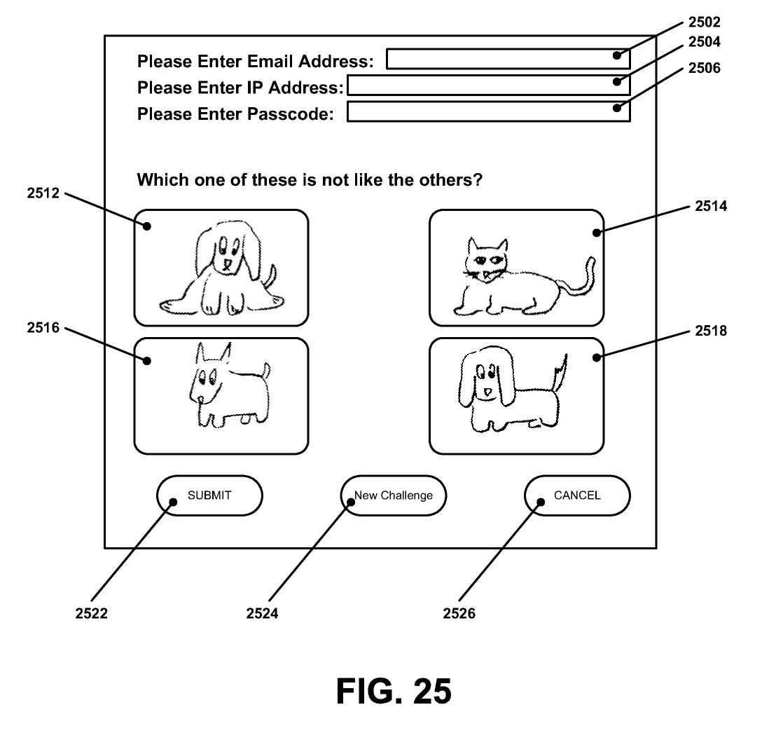

FIG. 25 shows an exemplary user interface offered by web interface 2404. Text fields 2502, 2504 and 2506 are available for the sender to enter email authentication information such as an email address, mail exchanger IP address, and/or a passcode in accordance with the requirements of the specific anti-spam system. The user interface also includes a WOOTINLTO challenge. There are many standard methods of indicating the solution, such as with a graphic accompanied by a check box or as depicted here with graphic buttons 2512, 2514, 2516 and 2518. The action of the graphic buttons can also be varied. In one variant clicking on a button selects that box as a solution and is somehow highlighted. The sender can then press submit button 2522 when the choice is made. In another variant, there is no submit button and pressing a graphic button simultaneously selects the solution and submits the submission. In addition, there can be new challenge button 2524. If the sender presses new challenge button 2524, a new challenge is offered. This is useful in the event the sender does not understand the challenge. Optionally there can be other standard buttons often seen on webpage forms such as cancel button 2526, a reset button (not shown) and/or a help button (also not shown). In addition, the webpage can also offer an audio button (not shown).

It should be emphasized that the above-described embodiments are merely examples of possible implementations. Many variations and modifications may be made to the above-described embodiments without departing from the principles of the present disclosure. For example, the embodiments described herein employ visually based children's cognitive tests. One of ordinary skill in the art can easily modify the teachings in this disclosure to employ other types of visually based cognitive tests which may not be typically considered a children's test. All such modifications and variations are intended to be included herein within the scope of this disclosure and protected by the following claims.

We claim:

1. A system comprising:
a human challenge module operable to generate a visual children's cognitive test and a solution to the visual children's cognitive test, said human challenge module comprising an image database from which the visual children's cognitive test is derived;
a challenge interface operable to present the visual children's cognitive test and to receive a solution to the visual children's cognitive test; and
a server operable to allow access to a restricted resource if a correct solution to the visual children's cognitive test is received.

2. The system of claim 1 wherein the challenge interface is a web interface and the web server presents the visual children's cognitive test through a web page.

3. The system of claim 1 wherein the visual children's cognitive test is a which one of these is not like the others (WOOTINLTO) test.

4. The system of claim 1 wherein the visual children's cognitive test is a find the object cognitive test.

5. The system of claim 1 wherein the visual children's cognitive test is a count the objects cognitive test.

6. The system of claim 1 wherein the visual children's cognitive test is a visual analogy cognitive test, a similar objects cognitive test, a two similar objects cognitive test, or a rhyming match cognitive test.

7. A system comprising:
a processor;
an interface to the end user;
an image database; and
memory comprising instructions; wherein
the instructions cause the processor to
generate a visual children's cognitive test from images in the image database;
incorporate the visual children's cognitive test in a web page;
provide the web page to the end user;
receive a response from the end user;
validate the response; and
release a restricted resource to the user if the response is validated.

8. The system of claim 7 wherein the restricted resource is a search result, a blog posting, a purchase transaction step, a file download, whitelisting in an anti-spam appliance or a combination thereof.

9. The system of claim 7 wherein the visual children's cognitive test is a WOOTINLTO test.

10. The system of claim 7 wherein the visual children's cognitive test is a similar objects cognitive test.

11. The system of claim 7 wherein the visual children's cognitive test is a find the object cognitive test.

12. The system of claim 7 wherein the visual children's cognitive test is a count the objects cognitive test.

13. The system of claim 7 wherein the visual children's cognitive test is a two similar objects cognitive test.

14. The system of claim 7 wherein the visual children's cognitive test is a visual analogy cognitive test.

15. The system of claim 7 wherein the visual children's cognitive test is a rhyming match cognitive test.

16. The system of claim 7, wherein the image database animal images and biological taxonomy information.

17. A method of determining whether an end user is a human comprising:
generating a visual children's cognitive test from images in the image database;
incorporating the visual children's cognitive test in a web page;
providing the web page to the end user;
receiving a response from the end user;
validating the response; and
releasing a restricted resource to the user if the response is validated.

18. The method of claim 17 wherein the restricted resource is a search result, a blog posting, a purchase transaction step, a file download, whitelisting in an anti-spam appliance or a combination thereof.

19. The method of claim 17 wherein the visual children's cognitive test is a WOOTINLTO test.

20. The method of claim 17 wherein the visual children's cognitive test is a find the object cognitive test, a count the objects cognitive test, a visual analogy cognitive test, a similar objects cognitive test, a two similar objects cognitive test, or a rhyming match cognitive test.
